(19) United States
(12) Patent Application Publication
(10) Pub. No.: US 2016/0212029 A1
(43) Pub. Date: Jul. 21, 2016

(54) PASSIVE DEVICE TO RECEIVE A CONTROL INPUT AND SUPPLY OUTPUT POWER

(71) Applicant: HEWLETT PACKARD ENTERPRISE DEVELOPMENT LP, Houston, TX (US)

(72) Inventors: Barry L. Goodwin, Roseville, CA (US); Sung Oh, Roseville, CA (US)

(73) Assignee: HEWLETT PACKARD ENTERPRISE DEVELOPMENT LP, Houston, TX (US)

(21) Appl. No.: 14/913,281

(22) PCT Filed: Aug. 22, 2013
(86) PCT No.: PCT/US2013/056269

§ 371 Date: Feb. 19, 2016

(51) Int. Cl. H04L 12/26; H04B 3/58; H04L 12/10

(52) U.S. Cl. CPC H04L 43/0817; H04L 12/10; H04B 3/58

(57) ABSTRACT

Examples disclose a passive device comprising a relay to receive a control input from a networking switch. The control input is received based on an identification of the passive device as power over Ethernet (PoE) compliant. The relay is further to supply an output power to a load. Additionally, the passive device is to receive the control input and supply the output power without a controller and associated coding.

### BACKGROUND

Devices under test, also referred to as units under test (UUT) may refer to manufactured products which undergo testing to determine if these units are functioning properly. Power control of these UUTs may rely on a dedicated controller to transmit power and data to carry out testing.

### BRIEF DESCRIPTION OF THE DRAWINGS

In the accompanying drawings, like numerals refer to like components or blocks. The following detailed description references the drawings, wherein:

FIG. 1 is a block diagram of an example passive device including a relay to receive a control input from a networking switch and output power to a load;

FIG. 2A is a circuit diagram of an example passive device including a power over Ethernet (PoE) circuit and relay, the passive device connected to a power over Ethernet (PoE) networking switch and a load;

FIG. 2B is a block diagram of an example passive device including a PoE circuit and silicon controlled rectified (SCR) relay to provide output power and a network connection to a load with a unit under test (UUT);

FIG. 3 is a flowchart of an example method to determine whether a passive device is power over Ethernet (PoE) compliant and based on the determination receive a control input and output power; and

FIG. 4 is a flowchart of an example method to implement a detection procedure to determine whether a passive device is power over Ethernet (PoE) compliant to receive a control input and output power to a load, accordingly.

### DETAILED DESCRIPTION

Power control over units under test (UUT) within a load may rely on a dedicated controller and associated coding to carry out functions The associated coding may include, but should not be limited to a source code, a program module, associated control data, an operating procedure, a code implementation, a program code, internal logic, or other type of coding for providing power control to the UUT. These controllers and their associated coding may not follow industry standards, such as IEEE® standards, which limits their implementation in various network configurations. Additionally, these controllers and their associated coding increase resources to design infrastructure, customize for a given network, and to maintain the associated coding.

To address these issues, examples disclosed herein provide a passive device without a dedicated controller and its associated coding to receive input power from a networking switch and supply to output power to a unit under test (UUT). The passive device provides a standardized configuration to support various networking systems to control power to the load without the use of the dedicated controller. This further eliminates customizing the network infrastructure to support the dedicated controller.

Additionally, the examples disclose the networking switch provides the input power to the passive device upon identifying the passive device as power over Ethernet (PoE) compliant. Power over Ethernet (PoE) is a system which may pass electrical power and data information along an Ethernet cable. This enables the Ethernet cable to provide both a data connection and electrical power to devices and ensures devices that are PoE compliant follow IEEE 802.3® standards. Identifying the passive device as PoE compliant provides a standardized communication protocol between the network switch and the passive device. This further provides the passive device to be used among multiple network configurations rather than customizing the passive device for use with a particular network. Additionally, confirming the passive device as PoE compliant prior to transmitting the control input, prevents other devices from stealing power from the networking switch.

In a further example, the control input includes an input power to the passive device. Providing the input power to the passive device enables the passive device to supply output power to the load. In this example, the networking switch may control the input power to the passive device and in turn power to the load. The passive device may condition the input power to boost the output power by the relay to the load. The relay may boost the output power by receiving a lower-powered signal (e.g., input power). In this example, the input power is a smaller magnitude of power than the output power or in other words, the output power is a larger magnitude of power than the input power.

In summary, examples disclosed herein provide a standardized configuration to support various networking systems to control power to a load without a use of a dedicated controller. Additionally, examples provide a standardized communication protocol rather than customizing a passive device for use within a particular network.

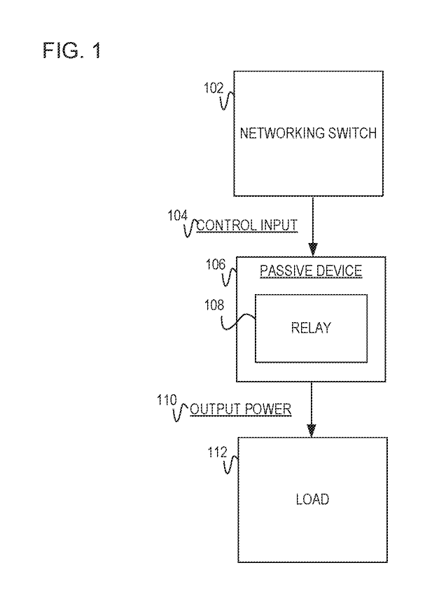

Referring now to the figures, FIG. 1 is a block diagram of an example passive device 106 including a relay 108 to receive a control input 104 from a networking switch 102. The passive device 106 delivers output power 110 to a load 112 upon receiving the control input 104. FIG. 1 is illustrative of a power over Ethernet (PoE) networking system including the networking switch 102, the passive device 106, and the load 112. The PoE describes a standardized networking system which passes electrical power (e.g., the control input 104) along with data on an Ethernet cable to the passive device 106. The passive device 106 may in turn transmit the output power 110 along with the data on the Ethernet cable to the load 112. As such, implementations of the PoE networking system may include Ethernet, wide area network (WAN), local area network (LAN), optic cable network, or other networking system capable of both providing support power over the Ethernet along with data. Additionally, although FIG. 1 illustrates the networking system including components 102, 106, 108, and 112, implementations should not be limited as this was done for illustration purposes. For example, the networking system may further include an interface between the networking switch 102, passive device 106, and/or load 112.

The networking switch 102 is a type of networking component capable of providing the physical connections to transmit both power and data through wired connections or wireless connections to the passive device 106 and in turn to the load 112. The networking switch 102 identifies the passive device 106 as PoE compliant and depending on whether the networking switch identifies passive device 106 as PoE compliant, the networking switch 102 may deliver the control input 104. Identifying the passive device 106 as PoE compliant means the passive device 106 complies with a set of standards as set forth in IEEE 802.3® for both receiving and transmitting electrical power and data information within the PoE networking system. In one implementation, the networking switch 102 may trigger the passive device 106 to determine whether the passive device is PoE compliant by initiating a communication protocol. The networking switch 102 controls the output power 110 to the load 112 by providing the control input 104 to the passive device 106 so the relay 108 may transmit the output power 110.

The control input 104 includes input power to the relay 108 which is conditioned by the relay 108 to generate the output power 110 to the load 112. In one implementation, the input power included in the control input 104 may be a magnitude lower of power than the output power 110 delivered to the load 112. Implementations of the input power as the control input 104 include a current, voltage, and/or other electrical charge capable of providing input power to the passive device 106. In another implementation, the control input 104 includes both the input power to the relay 108 and data information sent on the Ethernet cable. In this implementation, a port associated with the passive device 106 provides both the output power 110 and a network connection to the load 112.

The passive device 106 is an electronic device which includes the relay 108 to receive the control input 104 and output power 110 once receiving the control input 104. The passive device 106 is considered a slave device which upon receiving the control input 104, may provide the output power 110 to the load 112. The slave device both receives the control input 104 and supplies output power 110 without the use of a controller and its associated coding. Utilizing the passive device 106 provides a standardized configuration to support various networking systems to control power and provide the network connection without use of a dedicated controller. Although FIG. 1 illustrates the passive device 106 as including the relay 108, implementations should not be limited to this implementation as this was done for illustration purposes. For example, the passive device 106 may include other circuitry such as power over Ethernet (PoE) circuitry. This implementation is illustrated in later figures.

The relay 108 is an electrically operated switch that receives the control input 104 from the networking switch 102 once the passive device 106 is identified as PoE compliant by the networking switch 102. The relay 108 receives the control input 104 including the input power from the networking switch 102 once the networking switch 102 identifies the passive device 106 as PoE compliant. In this manner, the networking switch 102 may control the input to and from the passive device 106 to power the load 112. The passive device 106 controls the relay 108 by receiving a low-powered signal as the control input 104 and conditioning this low powered signal to produce a higher powered signal, output power 110. In one implementation, the relay 108 may include a silicon controlled rectified (SCR) relay to receive input power as the control input 104 and transmit output power 110 in a higher magnitude of power than the input power. The SCR relay is a solid state relay which is controlled by the passive device 106 by using a semiconductor to perform switching. The relay 108 controls the output power 110 delivered to the load 112 when receiving the control input 104. Implementations of the relay 108 include a solid state relay, solid state switch, semiconductor switch, semiconductor relay, or other type of electrically operated switch which may condition input power to provide the output power 110 to the load 112.

The output power 110 is supplied from the relay 108 to the load 112. The output power 110 is considered a higher-powered signal than the control input 104 to support higher-powered functions of the load 112. In one implementation, the output power 110 includes a network connection to transmit data which is delivered in addition to the output power 110. Implementations of the output power 110 include a current, voltage, and/or other electrical charge capable of providing output power to the load 112.

The load 112 receives the output power 110 from the relay 108 to support higher-powered functions within the load 112. For example, the higher powered functions may include, a server, another networking system, power switching, or other passive device. In one implementation, the load 112 includes a unit under test (UUT). In this implementation, the networking switch 102 may control testing of the UUT through supplying the control input 104 (e.g., input power) to the relay 108 and in turn, the relay 108 supplying the output power 110 to the load. Additionally, the passive device 106 may control the output power 110 without the use of a controller and associated programming which may increase resources of the networking system.

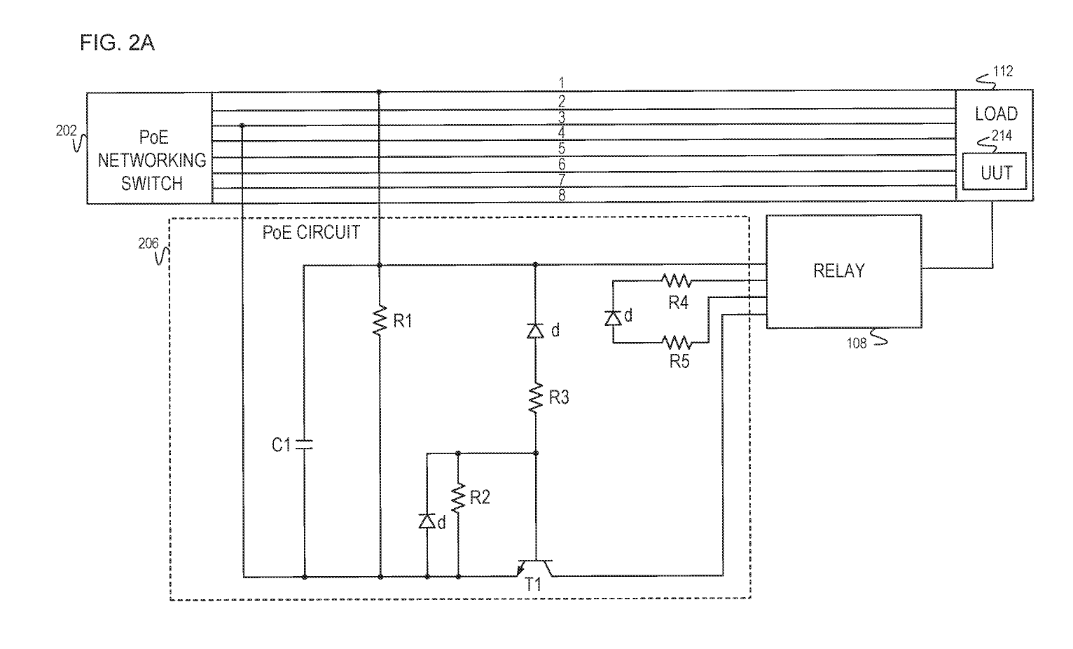

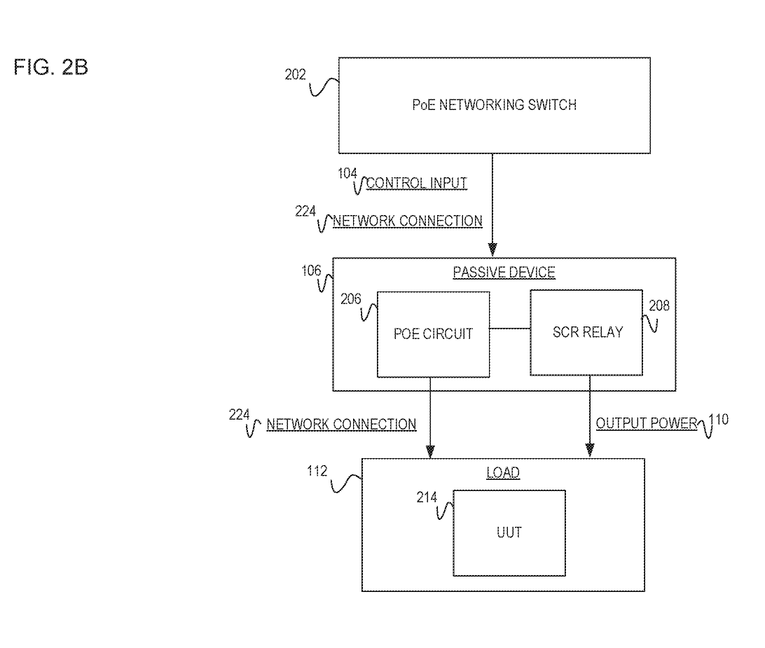

FIG. 2A is a circuit diagram of an example computing system including a passive device. The passive device includes a power over Ethernet (PoE) circuit 206 and a relay 108. The PoE circuit 206 receives a control input including input power from a PoE networking switch 202 to condition at the relay 108 to provide output power to a unit under test (UUT) as part of a load 112.

The PoE circuit 206 in FIG. 2A is a passive logic circuit which qualifies as PoE compliant. Once the PoE networking switch 202 recognizes the PoE circuit 206 as conforming to IEEE® standards for a PoE device, the PoE networking switch 202 provides a voltage between pins 1-2 and pins 3-6. The PoE circuit 206 in turn provides a voltage to the relay 108. The relay 108 upon receiving the voltage from the PoE circuit 206, provides the output power to the UUT 214 in the load 112. The passive device (not illustrated) includes both the PoE circuit 206 and the relay 108 between the PoE networking switch 202 and the load 112. The relay 108 may also include an additional power input (not illustrated) to provide the output power to the load 112.

The PoE networking switch 202 operates as a master device while the PoE circuit 206 operates as a slave device. In this implementation, the PoE networking switch 202 may use a controller to identify the PoE circuit 206 as PoE compliant and to transmit input power to the PoE circuit 206 upon the identification. The PoE circuit 206 is a passive circuit, meaning it operates without a dedicated controller. Using the PoE circuit 206 as passive eliminates the infrastructure and costs related to the dedicated controller.

The PoE circuit 206 includes a capacitor (C1), various resistors (R1-R5), various diodes (d), and a switch (T1) to control the voltage to the relay 108 and in turn output power to the load 112. The PoE networking switch 202 provides input power to the PoE circuit 206 upon identifying the PoE circuit 206 as PoE compliant. In this implementation, the PoE circuit 206 receives a voltage differential from the PoE networking switch 202 between pins 1-2 and pins 3-6 to control the output power on and off to the UUT within the load 112. To transmit the power to the PoE circuit 206, the PoE networking switch 202 receives a communication protocol, such as simple network management protocol (SNMP) to trigger the identification of the PoE circuit 206. SNMP is a standard communication protocol used to communicate with the networking switch 202 and in turn with the PoE circuit 206 to control the output power through the network. SNMP is a component of the Internet Protocol Suite which is defined by the Internet Engineering Task Force (IETF®) as a set of communication protocols for use with the Internet and/or Ethernet. SNMP works as a communication protocol between a collaborative system and the PoE networking switch 202. The communication protocol signals to the PoE networking switch 202 to identify whether the PoE circuit 206 is PoE compliant. The communication protocol may include a series of changes in magnitudes of voltages and/or currents between the PoE circuit 206 and the PoE networking switch 202 for the PoE circuit 206 to identify itself as PoE compliant to the PoE networking switch 206. The PoE networking switch 202 may measure each of the series of voltages and/or currents to authenticate the PoE circuit 206 as PoE compliant. Providing the standardized communication protocol enables the PoE circuit 206 and the relay 108 to be used among multiple network configurations rather than customizing the PoE circuit 206 for use with a particular network.

A collaborative system may transmit an SNMP communication protocol to the PoE networking switch 202 indicating to turn a port on associated with the PoE circuit 206 to receive the power. Upon receiving the SNMP communication protocol, the PoE networking switch 202 validates the port associated with the PoE circuit 206 as a PoE enabled device. The PoE networking switch transmits power on pins 1-2 and pins 3-6 which triggers the relay 108 to provide the output power to the UUT 214. To interrupt the flow of power to the PoE circuit 206, the PoE networking switch 202 turns off the voltage differential on pins 1-2 and pins 3-6 so the relay 108 no longer provides output power the UUT 214 and the UUT 214 in turn, shuts off.

FIG. 2B is a block diagram of an example passive device 106 including a power over Ethernet (PoE) circuit 206 and silicon controlled rectified (SCR) relay 208 to provide output power 108 and a network connection 224 to a load 112 with a unit under test (UUT) 214. The passive device 106 provides the output power 110 upon receiving a control input 104 from a PoE networking switch 202. FIG. 2B represents a PoE network system which may pass both electrical power and data information along an Ethernet cable. The electrical power is utilized by the passive device 106 to condition the power by the SCR relay 208 to obtain the output power 110 to the load 112. The PoE networking switch 202 may include a port to provide both the control input 104 and the network connection 224 to the passive device 106. In this implementation, an Ethernet cable may be used between the PoE networking switch 202 and the passive device to transmit control input 104 and network connection 224. Although FIG. 213 represents the network connection 224 and the output power 110 as separate cables between the passive device 106 and the load 112, this was done for illustration purposes rather than limiting purposes. For example, the network connection 224 and the output power 110 may be transmitted on a single Ethernet cable between the passive device 106 and the load 112.

The network connection 224 is a data connection provided by the PoE networking switch 202 to the passive device 106, and in turn to the load 112. The network connection 224 provides the data information in a string of characters, such as bits and/or bytes of values to represent the characters. Providing both the network connection 224 and the control input 104, the passive device 106 may provide both output power 110 and network connection 224 to the UUT 214.

The SCR relay 208 is a solid state relay which may receive a smaller control signal (control input 104) and condition the smaller control signal to generate a larger magnitude control signal (output power 110). The SCR relay 208 receives power from the PoE circuit 206 once the PoE circuit 206 receives the control input 104. Upon receiving power from the PoE circuit 206, the SCR relay 208 may provide the output power 110 to the load 112. In one implementation, the SCR relay 208 may receive alternating current (AC) and/or direct current (DC) and conditions the current to provide the output power 110 as AC power to the load 112.

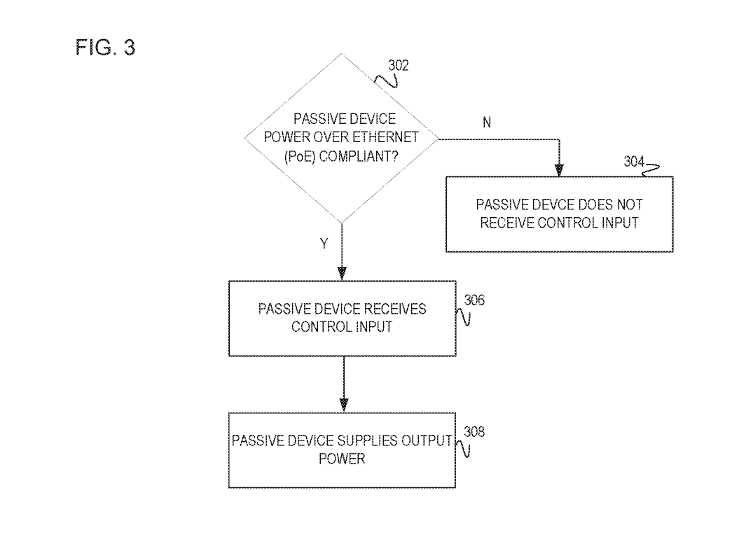

FIG. 3 is a flowchart of an example method for a networking switch to determine whether a passive device is power over Ethernet (PoE) compliant. Once determining the passive device is PoE compliant, the method proceeds to operations 306-308. At operations 306-308, the passive device receives a control input from the networking switch and supplies output power to a load. If the networking switch determines the passive device is not PoE compliant, the method proceeds to operation 304 in which the passive device does not receive the control input. In this regard, the networking switch may control the output power to the load through the passive device without the use of a controller and associated coding to execute operations 302-308. In discussing FIG. 3, references may be made to the components in FIGS. 1-2B to provide contextual examples. In one implementation of FIG. 3, the networking switch 102 and the passive device 106 communicate for carrying out operations 302-308. Further, although FIG. 3 is described as implemented by the passive device 106 as in FIG. 1, it may be executed on other suitable components. For example, FIG. 3 may be implemented by a PoE circuit 206 and/or relay 108 as in FIGS. 1-2.

At operation 302, the networking switch determines whether the passive device is PoE compliant. PoE is a term which describes a standardized system which enables electrical power and data information to be transmitted over an Ethernet cable. PoE is considered a set of standards as set forth in IEEE 802.3®. PoE is a system whereby a small amount of electrical current is sent over the network cable. Transmitting the small amount of electrical current enables the passive device to draw power from the network, eliminating an additional power source to power the passive device. PoE compliant device means the networking switch recognizes the passive device as a PoE circuit which conforms to the IEEE® standards. As such, the passive device may include specialized internal circuitry and other components which enable the passive device to accommodate PoE. For example, the passive device may include features to gather and utilize the electrical power and data from the Ethernet cable. Accommodating PoE to receive both input and data means the device is considered PoE compliant. At least one communication may be exchanged from the passive device to the networking switch to identify itself as PoE compliant.

In a further implementation, a collaborative system may implement a simple network management protocol (SNMP) to trigger the networking switch for the determination at operation 302. SNMP is considered an internet-standard communication protocol for managing various devices (e.g., the passive device, the networking switch, etc.) on internet and/or Ethernet networks. SNMP is part of the internet protocol suite as defined by the Internet Engineering Task Force (IETF®) and consists of a set of standards for communication protocols within a network. In other implementations, if the networking switch determines the passive device is not PoE compliant, the method proceeds to operation 304. In further implementations, if the networking switch determines the passive device is PoE compliant, the method proceeds to operations 306-308.

At operation 304, once the networking switch determines the passive device is non-PoE compliant, the passive deice does not receive the control input. Control input includes input power, a signal, an indicator, and/or other type of communication transmitted from the networking switch to the passive device. Managing the control input based on the determination the passive device is PoE compliant provides an additional control aspect to control whether the passive device may output power to the load.

At operation 306, once the networking switch identifies the passive device as PoE compliant, the passive device receives the control input from the networking switch. Once the networking switch recognizes the passive device as conforming to the IEEE® standards for a PoE device (e.g., PoE compliant), the PoE networking switch provides the control input to the passive device. The control input may include an input power and as such, providing the input power enables the passive device to output power to the load as at operation 308. In this manner, the networking switch may control the input power to the passive device and in turn power to a load. In another implementation, the networking switch may provide input power to a relay which may boost the input power to provide the output power to the load. The relay is an electrically operated switch which controls the output power to the load by receiving a lower-powered signal. In this implementation, the input power is a smaller magnitude of power than the output power or in other words, the output power is a larger magnitude of power than the input power.

At operation 308 the passive device supplies the output power to the load. At operation 308, once the passive device receives the input power included in the control input received at operation 306, the passive device may then supply the output power to the load. In another implementation, the load may include a unit under test (UUT). In this implementation, the networking switch may control the testing of the UUT through the passive device without the use of a controller and programming associated with the controller to execute operations 302-308.

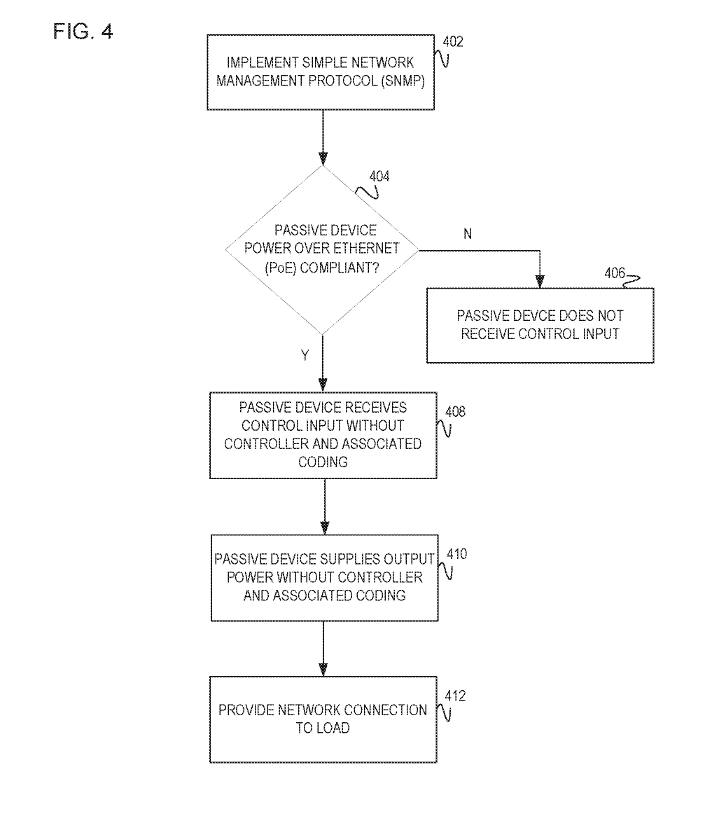

FIG. 4 is a flowchart of an example method to implement a simple network management protocol (SNMP) to determine whether a passive device is power over Ethernet (PoE) compliant to receive a control input and output power to a load, accordingly. In discussing FIG. 4, references may be made to the components in FIGS. 1-2B to provide contextual examples. In one implementation of FIG. 4, a networking switch 102 and passive device 106 collaborate communications to execute operations 402-412. Further, although FIG. 4 is described as implemented by the passive device 106 as in FIG. 1, it may be executed on other suitable components. For example, FIG. 4 may be implemented by a PoE circuit 206 and/or relay 108 as in FIGS. 1-2.

At operation 402, a collaborative system may implement a simple network management protocol to trigger the networking switch to determine whether the passive device is PoE compliant as at operation 404. The SNMP is an Internet standard protocol of managing devices (e.g., the networking switch) on the network. SNMP is a component of the Internet Protocol Suite, defined by the Internet Engineering Task Force (IETF) which is a set of communication protocols for use with the Internet and/or Ethernet. SNMP works as a communication protocol between a collaborative system and the networking switch which signals to the networking switch to identify the passive device as PoE compliant. The networking switch may then utilize a standardized detection procedure to communicate with the passive device. In this implementation, the networking switch utilizes the IEEE 802.3af® Powered Device (PD) detection procedure to communicate with the passive device to determine whether the passive device is PoE compliant. At operation 402, the communication protocol of the standardized detection procuedure may include a series of changes in magnitudes of voltages and/or currents between the passive device and the networking switch for the passive device to identify itself as PoE compliant to the networking switch. The networking switch may measure each of the series of changes in voltages and/or currents to authenticate the passive device as PoE compliant. Providing the standardized communication protocol for the passive device to the networking switch enables the passive device to be used among multiple network configurations rather than customizing the passive device for use with a particular network.

At operation 404, the networking switch determines whether the passive device is PoE compliant. At operation 404, the networking switch may wait until identifying the passive device as PoE compliant until providing the control input to the passive device as at operation 408. Confirming the passive device as PoE compliant prior to transmitting the control input prevents other devices from stealing power over the PoE network. If the networking switch determines the passive device is PoE compliant, the method proceeds to operations 408-412. If the networking switch determines the passive device is non-PoE compliant, the method proceeds to operation 406. Operation 404 may be similar in functionality to operation 302 as in FIG. 3.

At operation 406, the networking switch may determine the passive device is non-PoE compliant. Operation 406 may be similar in functionality to operation 304 as in FIG. 3.

At operations 408-410, the networking switch transmits the control input to the passive device for the passive device to supply output power to the load. The control input includes input power which provides the power between pins associated with the passive device and then in turn to a relay. The relay receives the control input (e.g., input power) and conditions the input power to provide the output power. In this implementation, the relay may control power to the load. The control input from the networking switch to the passive device enables the passive device to provide the output power. In this manner, the networking switch may control power to the load through the passive device as the passive device may provide the output power once receiving the control input from the networking switch. Additionally the method carries out operations 408-410 on the passive device without a controller and its associated coding, instructions, etc. Carrying out operations 408-410 without the controller and its associated coding provides a standard configuration without customizing the network infrastructure to support the controller and its coding. Further, it eliminates costs and maintenance associated with these components. Further it also enables the passive device for utilization among various networking systems to control the power and provide a network connection as at operation 412. Operations 408-410 may be similar in functionality to operations 306-308 as in FIG. 3.

At operation 412, the passive device may also provide a network connection to the load. As explained earlier, PoE provides both power to a device and data. The network connection provides the data connection to the load in addition to the power.

In summary, examples disclosed herein provide a standardized configuration to support various networking systems to control power to a load without a use of a dedicated controller. Additionally, examples provide a standardized communication protocol rather than customizing a passive device for use within a particular network.

1. A passive device comprising:
a relay to:
receive a control input from a networking switch based on an identification the passive device as power over Ethernet (PoE) compliant; and
supply an output power to a load;
wherein the passive device is to receive the control input and supply the output power without a controller and associated coding.

2. The passive device of claim 1 further comprising:
a power over Ethernet (NE) circuit to implement a standardized detection procedure for the networking switch to identify the passive device as PoE compliant to the networking switch.

3. The passive device of claim 1 wherein there is a one-to-one correspondence between the passive device and a port associated with the networking switch.

4. The passive device of claim 1 wherein the relay is a silicon controlled rectifier relay and the control input is input power and further wherein the output power supplied by the relay is a higher magnitude of power than the input power received from the networking switch.

5. The passive device of claim 1 wherein the load includes a unit under test (UUT) and the passive device is further comprising:
a power connection to supply the output power to the UUT; and
a network connection to provide network connectivity from the networking switch to the UUT.

6. A method, executable by a passive device, the method comprising:
receiving a control input, by the passive device from a networking switch, based on a determination the passive device is power over Ethernet (PoE) compliant; and
supplying an output power, by the passive device to a load, the output power a larger magnitude of power than the control input.

7. The method of claim 5 wherein the determination the passive device is POE compliant, the method is further comprising:
implementing a standardized detection procedure between the networking switch and the passive device to identify the passive device as PoE compliant.

8. The method of claim 5 wherein if the networking switch determines the passive device is not PoE compliant, the passive device does not receive the control input.

9. The method of claim 5, wherein the passive device is to receive the control input and supply the output power without a controller and associated coding.

10. The method of claim 5 further comprising:
providing a network connection to the load, by the passive device.

11. A computing system comprising:
a passive device to:
receive a control input from a networking switch based on a determination by the networking switch the passive device is power over Ethernet (PoE) compliant; and
supply an output power to a load upon receiving the control input from the networking switch.

12. The computing system of claim 11 wherein the passive device is comprising:
a relay to:
recive input power as part of the control input from the networking switch; and
supply the output power to the load, the output power a higher magnitude of power than the input power.

13. The computing system of claim 11 wherien the passive device is comprising a PoE circuit to receive the control input, wherein the passive device is to receive the control input and supply the output power without a controller and associated coding.

14. The computing system of claim 11 further comprising:
PoE networking switch to determine whether the passive device is PoE complian by communicating with the passive device using a standardized detection procedure.

15. The computing system of claim 11 further comprising:
a load to receive the output power for operating a unit under test (UUT).
